(19) United States
(12) Patent Application Publication
(10) Pub. No.: US 2025/0119987 A1
(43) Pub. Date: Apr. 10, 2025

(54) HIGH TEMPERATURE INDUCTION HEATING SYSTEMS AND METHODS

(71) Applicant: Lummus Technology LLC, Bloomfield, NJ (US)

(72) Inventor: Nir VAKS, Bloomfield, NJ (US)

(21) Appl. No.: 18/910,188

(22) Filed: Oct. 9, 2024

Related U.S. Application Data
(60) Provisional application No. 63/588,894, filed on Oct. 9, 2023.

(51) Int. Cl. H05B 6/10; H05B 1/02

(52) U.S. Cl. CPC H05B 6/101; H05B 1/0247; H05B 2206/023; H05B 2214/03

(57) ABSTRACT

An induction heating system and method includes a work piece that may be a multi-layer pipe. The multi-layer pipe includes an inner layer for conveying effluent and an outer layer surrounding at least a portion of the inner layer. The outer layer has a higher Curie temperature than the inner layer such that the outer layer remains magnetic at or above a reaction temperature of the effluent to maximize hysteresis losses in the pipe up to and beyond the reaction temperature of the effluent. The inner layer may have desirable mechanical, thermal, and chemical properties such that the combination of the outer layer and the inner layer results in a multi-layer pipe that is efficient for induction heating up to and beyond the reaction temperature, while also being mechanically and thermally suitable for hydrocarbon processing applications.

### BACKGROUND

### Technical Field

The present disclosure is generally directed to induction heating systems and methods, and is more particularly, but not exclusively, directed to high temperature induction heating systems and methods for hydrocarbon processing.

### Description of the Related Art

Various systems and methods are known for processing hydrocarbons. Processing equipment and parameters vary significantly in different hydrocarbon processing applications, such as based on the input feedstock, desired output effluent, reactor type and heat source, and many other factors. At a very high level, many hydrocarbon processing applications involve heating the feedstock to a reaction temperature, at which point, the feedstock undergoes a chemical reaction to produce the desired output effluent. In conventional hydrocarbon processing applications, such heating is provided by a fired heater that burns fossil fuels to provide the heat of reaction. However, the use of fossil fuels results in emissions that can be harmful to the environment and may, in some cases, be contrary to regulations restricting the types or amounts of emissions.

In response, various solutions have been proposed that rely on electricity to provide the heat of reaction instead of fossil fuels or fired reactors in an attempt to reduce the environmental footprint of hydrocarbon processing while also complying with industry regulations. There are three different electric heating methods currently being studied for hydrocarbon processing applications, namely radiation or convection heating, direct heating, and electromagnetic or induction heating. In radiation or convection heating, electricity is provided to a heating element to heat air. The hot air contacts a pipe containing a process fluid, with the hot air heating the process fluid in the pipe through radiation or convection. With direct heating, the pipe itself is heated by providing electricity to the pipe that encounters resistance flowing through the pipe to generate heat. Finally, with electromagnetic or induction heating, electricity is provided to a coil or wire to generate electromagnetic waves that flow through a pipe. The flow of the waves through the pipe generates heat through eddy current loss and hysteresis loss, both of which are explained further herein.

Recently, induction heating has been studied as a preferred option because of potential advantages such as the lack of moving parts and lack of contact with the process pipe, among others. However, previous induction heating solutions have drawbacks as well, including that common materials for hydrocarbon processing experience a reduction in magnetic properties as temperatures increase, which leads to significant reductions in efficiency. Countering such an issue relies on process pipes made from expensive materials that may have poor mechanical strength. Other prior solutions rely on sophisticated and expensive power electronics to enable high switching frequency to increase magnetic flux or have issues with reduced flux penetration, among others.

As a result, it would be beneficial to provide high temperature induction heating systems and methods that overcome the deficiencies of known solutions.

### BRIEF SUMMARY

The present disclosure is generally directed to systems and methods for induction heating, and is more particularly, but not exclusively, directed to induction heating for high temperature applications, such as hydrocarbon processing. The present disclosure contemplates the use of a multi-layer pipe as the workpiece or object to be heated by induction heating. In a preferred example, the multi-layer pipe is a bi-layer pipe with an inner layer and an outer layer. The inner layer is in contact with an effluent during operation and the outer layer is spaced from the effluent at least across the inner layer. The outer layer preferably does not contact the effluent during operation. The outer layer may be cobalt-based, or more specifically, an iron cobalt-based alloy with a Curie temperature above 900 degrees C. The inner layer may be a nickel-based alloy, such as 2535 alloy that is commonly used for effluent pipes in the industry with a Curie temperature of around 600 degrees C.

Because of the higher Curie temperature, the outer layer remains magnetic at or above the reaction temperature for many hydrocarbon processing applications, including the production of ethylene. Such an arrangement enables the pipe to maximize hysteresis and eddy current losses in the pipe up to, and beyond, the reaction temperature to result in a more efficient workpiece for induction heating. In some examples, the outer layer is shrink fit to the inner layer at operational temperatures such that heat generated in the outer layer is transferred to the inner layer, and thus to the effluent, by direct contact between the layers and/or by convection.

Additional features and advantages of the concepts of the disclosure are explained in more detail below.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1 is a schematic illustration of an induction heating of a pipe.

FIG. 2 is a schematic illustration of induction heating of a pipe in a hydrocarbon processing system.

FIG. 3 is a cut away view of an implementation of a pipe according to the present disclosure.

FIG. 4A and FIG. 4B are cross-sectional views of the pipe of FIG. 3 at room temperature and at operational temperature, respectively.

FIG. 5 is a schematic illustration of induction heating of a pipe in a hydrocarbon processing system according to the present disclosure.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide induction heating devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to high temperature induction heating systems and methods that are particularly advantageous for hydrocarbon processing. As will be described in more detail below, the concepts of the disclosure enable effective and efficient heating of a workpiece, such as a pipe or tube, using induction heating. The pipe or tube may have a selected cross-sectional shape, including but not limited to circular, elliptical, square, triangular, and the like. In some examples, the techniques discussed herein rely on a multi-layer pipe with an outer layer including an iron cobalt-based alloy having relatively high Curie temperature and high magnetic capabilities, and an inner layer with a material having relatively lower Curie temperature (such as a nickel, iron, and/or steel alloy) and lower magnetic capabilities to enable efficient effluent heating at temperatures above 800 degrees C., although the disclosure is not limited thereto. Such multi-layer pipe may have the cross-sectional shapes discussed above for either or both layers, or the cross-sectional shapes of the layers may be different.

Although the concepts of the disclosure will be explained below in the context of systems and methods for the production of ethylene, it is to be appreciated that the techniques discussed herein can be applied equally to other hydrocarbon processing applications, including without limitation any hydrocarbon processing application that utilizes a heater, furnace, or other like device to generate heat for processing. Further, the techniques of the disclosure can be implemented in newly built electric reactors or heaters as well as in retrofit applications that either update existing electrical heating technology with the techniques discussed herein or replace a fired furnace with an electric heater that relies on the techniques discussed herein.

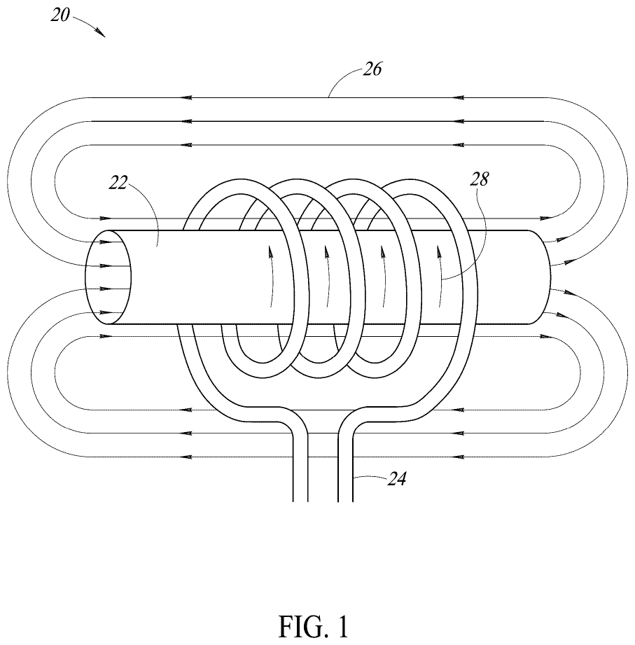

FIG. 1 is a schematic illustration of an induction heating system 20 for a workpiece 22, such as a pipe. The system 20 includes the workpiece 22 and a wire or source 24. Induction heating is an important technology in many processes from alloy processing, chemical processing, home cooking, and other fields. By using electromagnetic induction, heat is generated directly within the material or the workpiece 22, which can allow for fast and efficient heating of the workpiece 22 without contact with the workpiece 22 or external heating sources. These advantages result in reduced processing times and increased productivity.

Generally, induction heating, such as with system 20, produces heat by inducing magnetic flux in the wire or source 24 via current through the wire 24. The magnetic flux is illustrated schematically in FIG. 1 with arrows 26 and the current through the wire 24 is illustrated schematically in FIG. 1 with arrows 28. The magnetic flux 26 crosses the workpiece 22 and generates heat in the workpiece 22 by inducing core loss. The higher the amount of core loss, the more energy that is deposited into the workpiece 22, thus resulting in more heat in the workpiece 22. As a result, preferred materials for the workpiece 22 for efficient induction heating of the workpiece 22 include materials that maximize the core loss. Core loss can include two different components: (i) hysteresis loss in a magnetic material, which depends upon the reversal of the magnetism; and (ii) eddy current loss, which occurs because of interaction between the conductor and the magnetic material. More specifically, hysteresis loss occurs because of friction that results from a change of direction of the magnetic flux 26 through the workpiece 22. The magnetic flux 26 penetrating the workpiece 22 generates electric currents in the workpiece 22 that are called eddy currents. The eddy currents flow through the resistance of the material and thus heat the workpiece 22 by Joule heating against the resistance (which may also be called resistance heating).

In order to maximize the overall loss in the workpiece 22, it is preferred to maximize both hysteresis and eddy current loss and, as a result, maximize the full thermal potential. Hence, a preferred workpiece 22 will be one that maximizes both loss components to generate efficient heating of the object. The overall loss can be calculated by the following equation:

$${P}_{l o s s} = {P}_{e} + {P}_{h}$$

with the eddy current loss (Pₑ) being approximated by equation (1) below:

$${P}_{e} = {K}_{e} \times {{B}_{max}}^{2} \times {f}^{2} \times {t}^{2} \times V \qquad ( 1 )$$

where,
Pₑ=eddy current loss (W)
Kₑ=eddy current constant
B=flux density (Wb/m²)
f=frequency of magnetic reversals per second (Hz)
t=material thickness (m)
V=volume (m³)
and the hysteresis loss (Pₕ) is approximated by equation (2) below:

$${P}_{h} = η \times {{B}_{max}}^{n} \times f \times V \qquad ( 2 )$$

where,
Pₕ=hysteresis loss (W)
n=Steinmetz hysteresis coefficient, depending on material (J/m³)
Bₘₐₓ=maximum flux density (Wb/m²)
n=Steinmetz exponent, ranges from 1.5 to 2.5, depending on material
f=frequency of magnetic reversals per second (Hz)
V=volume of magnetic material (m³).
   As a result, substituting equations (1) and (2) into the overall loss equation above yields the following calculation of the overall loss:

$${P}_{l o s s} = {K}_{e} \times {{B}_{max}}^{2} \times {f}^{2} \times {t}^{2} \times V + η \times {{B}_{max}}^{n} \times f * V$$

Based on this loss equation, the maximization of losses heavily depends on several factors, including material characteristics, size, frequency, and flux density. Furthermore, in order to maximize flux density (Bₘₐₓ) at a given current excitation, it is preferred to maximize the permeability and saturation (B vs. H) of a given workpiece, such as workpiece 22. Magnetic materials with strong permeability are also known as Ferromagnetic materials and contain a significant amount of Iron (Fe), Cobalt (Co), Nickel (Ni), and/or Gadolinium (Gd). As the workpiece 22 increases in temperature, its permeability and flux density tends to decrease. Once the workpiece 22 reaches the so-called Curie temperature, the material become significantly less magnetic or non-magnetic, which eliminates hysteresis losses and decreases overall heating efficiency.

If the workpiece 22 is magnetic, such as carbon steel, it will be heated by the two components of core loss in induction heating, namely eddy current loss (which may also be referred to herein as “eddy current heating”) and hysteretic loss (which may also be referred to herein as “hysteretic heating”). Hysteretic heating is very efficient up to the Curie temperature, which for steel is 600 degrees C. (approximately 1100 degrees Fahrenheit). At or beyond the Curie temperature, the magnetic relative permeability reduces close to 1 (i.e., the material becomes less magnetic or non-magnetic), which eliminates hysteresis losses. As a result, both the flux density on the workpiece tends to reduce and the eddy current is left to do the heating, which results in less efficient heating compared to heating at higher permeability and the combination of hysteresis loss and eddy current loss.

In terms of magnetic performance, it is preferable that the workpiece 22 be attractive to magnetic flux (i.e., have a high permeability) in a wide range of temperatures and magnetic field intensities because the more magnetic flux that passes through the workpiece 22, the more eddy current loss and hysteresis loss that can be achieved to result in more efficient heating. In other words, referring back to the loss equations above, the eddy current loss and hysteresis loss are a function of ˜B\hat{ }2. As a result, there is significant benefit to maximizing the flux density (Bₘₐₓ) in the workpiece 22 because doing so will increase hysteresis and eddy current losses in workpiece 22, thereby improving heating of the workpiece 22.

In hydrocarbon processing applications, many workpieces 22 are pipes or tubes that are a steel and/or iron alloy with a Curie temperature around 600 degrees C. For high temperature induction heating applications, such as hydrocarbon processing, the heat of reaction is often above 600 degrees C. In a non-limiting example, the heat of reaction for production of ethylene may be about 750 degrees C. to 850 degrees C. As a result, common materials for workpieces or pipes in hydrocarbon processing will become non-magnetic before reaching the reaction temperature, resulting in less efficient heating via eddy current losses only.

In response, certain solutions have been proposed that attempt to increase magnetic flux to induce more and more eddy current loss to counter the loss of hysteresis losses above the Curie temperature. There are several drawbacks with such approaches, including that efficiency tends to reduce at temperatures above the Curie temperature for a given workpiece 22. Solutions that rely on an increase in magnetic flux frequency to induce additional eddy current losses utilize sophisticated and expensive power electronics that enable the high switching frequency, which are likewise an impractical solution. Increasing frequency also results in reduced flux penetration and hence uneven distribution of the heat flux within the cross-sectional area of the workpiece 22. As a result, present solutions for high temperature induction heating are inefficient and expensive to implement, among other deficiencies.

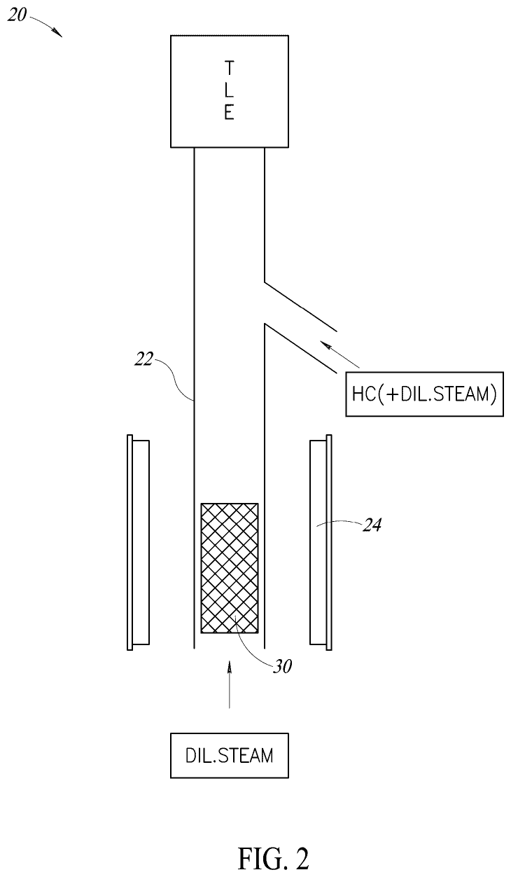

FIG. 2 is a schematic illustration of the induction heating system 20 for workpiece 22. Where the workpiece 22 is a pipe, such as for hydrocarbon processing, effluent flows within the core of the pipe (or inside the inner diameter of the pipe). The effluent is heated via direct contact with the inner surface of the pipe, which is typically an iron-based alloy. As a result, and based on the above factors, prior solutions believed it would be most efficient to use an alloy with a higher Curie temperature inside the pipe and closest to the effluent. Such an arrangement is illustrated schematically in FIG. 2 where an alloy 30 with a Curie temperature above 600 degrees is placed within the workpiece 22 or pipe. The inner diameter of the pipe 22 itself may be formed of the alloy 30 or the alloy 30 may be placed inside the pipe 22. As such, the alloy 30 is in contact with the effluent through the pipe 22, which in a non-limiting example is dilution steam. Magnetic flux is generated by susceptors 24 that induce hysteresis and eddy current losses in the pipe 22 and/or the alloy 30 to heat the effluent or dilution steam flowing through the pipe 22 by direct contact with the alloy 30.

The issue with such approaches is that they fail to consider the heating depth of magnetic penetration. In general, magnetic flux will penetrate the surface of the pipe 22 with approximately 80% of the heat produced at the outer surface of the pipe 22 due to a phenomenon known as the skin effect. In order words, the outer surface of the pipe 22 is most effective at generating hysteresis and eddy current losses because of the relatively shallow depth of the magnetic flux penetration from the susceptors or other source. It is also noted that higher operating frequencies of the magnetic flux, such as using control electronics that induce a high amount of frequency switching, tend to have shallower penetration depth (i.e., shallower skin depth) while lower frequencies have high penetration depth. As a result, solutions that rely on a high Curie temperature alloy inside the workpiece or pipe 22 are not efficient at heating the effluent because a majority of the magnetic flux does not penetrate through the pipe due to the skin effect. Instead, the relatively lower Curie temperature outer material, such as a steel or iron-based alloy, loses magnetism at high temperatures and eliminates a majority of hysteresis loss due to the skin effect.

Other solutions may consider making the entire pipe 22 out of a material with a high Curie temperature. However, materials with a high Curie temperature have mechanical, thermal, structural, and chemical weaknesses that prevent use of such materials for a pipe 22 of the type considered herein. For example, alloy with high Co content tends to have higher Curie temperature, but tends to be relatively brittle at higher thicknesses and lengths of the type utilized for pipes 22 in hydrocarbon processing applications. High Curie temperature materials also often require high-cost chemistry and/or processing, making them prohibitively expensive for use as the sole material of a pipe 22 for induction heating in hydrocarbon processing applications.

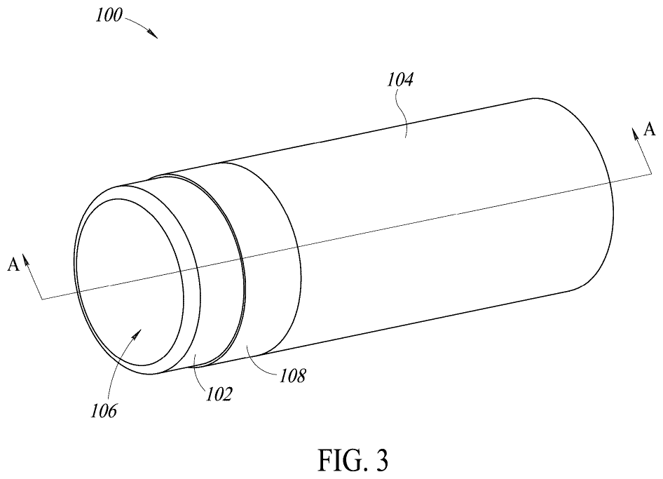

FIG. 3 is a cut away view of an implementation of a pipe 100 according to the present disclosure. To overcome the above deficiencies of workpieces for induction heating in hydrocarbon processing applications, it is contemplated herein to use a multi-layer pipe 100 as the workpiece where the layers of the pipe 100 include different materials. More specifically, the pipe 100 includes at least an inner layer 102 (which may also be an inner pipe 102) and an outer layer 104. In an implementation, the inner layer 102 of the pipe 100 is an inner-most layer 102 with the effluent flowing through and in contact with an inner surface 106 of the inner layer 102. The effluent may include, but is not limited to, any chemical process fluid. Thus, the techniques discussed here can be applied to heat any chemical process fluid. The outer layer 104 may be an outermost layer of the pipe 100 and may not be in direct contact with the effluent flowing through the inner layer 102. Instead, the outer layer 104 may be in contact with, or proximate to, an outer surface of the inner layer 102. In some implementations, the pipe 100 includes one or more additional layers 108. The additional layers 108 are preferably one or more intermediate layers between the inner layer 102 and outer layer 104, although the same is not necessarily required. The additional layers 108 may also be inside or outside of the inner layer 102 and outer layer 104. In a preferred implementation, the additional layers 108 are omitted and the pipe 100 includes only the inner layer 102 and the outer layer 104.

The inner layer 102 and the outer layer 104 preferably have a different material composition. While the inner layer 102 and the outer layer 104 can include selected materials, it is preferred that the outer layer 104 be a material with a higher Curie temperature than the inner layer 102 to induce additional losses in the outer layer 104 according to the skin effect described herein while maintaining magnetism at or above the reaction temperature for a given processing application. In a preferred implementation, the outer layer 104 is a cobalt-based alloy, and more preferably, an iron cobalt-based alloy with a Curie temperature above 600 degrees C., and more preferably above about 800 degrees C. In an implementation, the outer layer 104 has a Curie temperature of 938 degrees C. The inner layer 102 may be a cold hardened nickel-based alloy of the type commonly used in the industry, among other options.

In a non-limiting example, the iron-cobalt based alloy may be an iron cobalt vanadium alloy sold under the brand name Hiperco® 50A and the cold hardened nickel-based alloy may be 2535 alloy. It should be appreciated that many other materials are suitable for the layers 102, 104 and are contemplated herein. For example, the inner layer 102 may be a steel, iron, and/or nickel-based alloy of different hardness and other characteristics. While the outer layer 104 is preferably an iron cobalt-based material, the outer layer 104 may also be a cobalt-based material more generally, such as a material with cobalt present in an amount from 10% to 50% by weight, or in some cases, more than 50% by weight cobalt. In further non-limiting examples, the inner layer 102 or outer layer 104, or both, can be any magnetic and/or non-magnetic material. While it is preferred that the outer layer 104 is a cobalt-based alloy with a higher Curie temperature relative to a nickel-based alloy of the inner layer 102, configurations are contemplated herein where the outer layer 104 is instead a nickel-based alloy or another material with a lower Curie temperature relative to an inner layer 102 that is a cobalt-based alloy or another material with a higher Curie temperature than the outer layer 104. The inner layer 102 may have desirable mechanical, thermal, and chemical properties relative to the outer layer 104. One measure of the mechanical strength of the layers 102, 104 is the elastic modulus. In an implementation, the outer layer 104 has a higher elastic modulus than the inner layer 102, meaning that the outer layer 104 is more rigid than a similarly sized and shaped inner layer 102 under at least tensile stress. In non-limiting examples where the outer layer 104 is iron cobalt vanadium alloy, the elastic modulus of the alloy may be 30×10³ kilopounds per square inch (206.8 Gigapascals) whereas the nickel-based 2535 alloy may have an elastic modulus of 28.3×10³ kilopounds per square inch (195.1 Gigapascals). One measure of the thermal properties of a material is the thermal conductivity of the material. In an implementation, the outer layer 104 has a higher thermal conductivity than the inner layer 102.

Utilizing a cobalt-based material as the outer layer 104 enables the pipe 100 to maintain magnetism (i.e., the outer layer 104 has a higher Curie temperature relative to the inner layer 102 and therefore increases the Curie temperature of the pipe 100) while also maximizing magnetic permeability and efficiency in induction heating. In some implementations, the thickness of the cobalt-based alloy (i.e., outer layer 104) is optimized to the induced frequency of the magnetic field. In other words, and as described above, the thickness of the cobalt-based alloy may be adapted to the operational frequency to maximize the skin effect at the outer layer 104 and induce additional losses, and therefore more efficient heating, at the outer layer 104. The result of such adaption of the thickness may result in a thicker outer layer for lower frequencies and a thinner outer layer for higher frequencies of the magnetic field. The thickness of the outer layer 104 may also be selected based on additional factors, including, but not limited to, the flux penetration (as a function of frequency), heat requirements, and mechanical constraints.

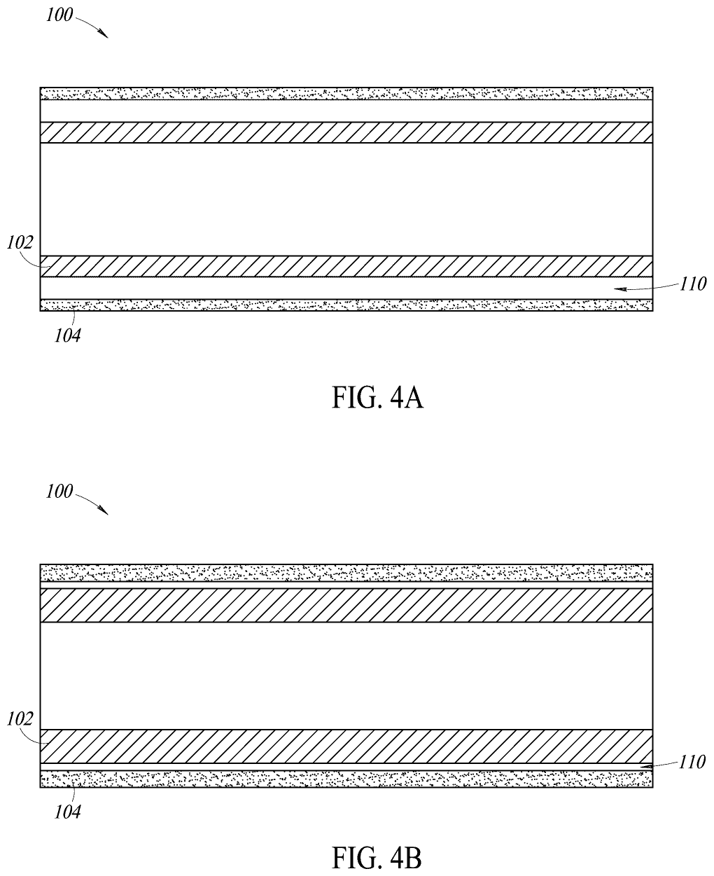

In an implementation, the iron cobalt-based alloy (or cobalt-based alloy generally) is provided in sheet form and may be a continuous layer. In one or more implementations, the inner layer 102 or the outer layer 104, or both, are not formed or otherwise manufactured as a single continuous piece such as a wrought alloy, but can also be made, formed, or manufactured out of multiple separate and discrete pieces following by subsequent processing to form the layers 102, 104. Where either or both layers 102, 104 are a continuous sheet, they can be rolled to form to create the pipe 100. Where either or both layers 102, 104 are multiple separate and discrete pieces, the pieces can be joined by a number of available methods, including but not limited to, by welding, with fasteners, and the like. Thus, a method for making or manufacturing the pipe 100 may include surrounding the inner layer 102 with a layer or sheet of iron cobalt-based alloy sheet material with a selected thickness based on the intended operational frequency of the induced magnetic field to form the outer layer 104. In various implementations, the pipe 100 may be secured to a structural frame or other aspects of a hydrocarbon processing system with the outer layer 104 secured to the inner layer 102 at ends of the pipe 100 where the pipe 100 is joined to brackets, fasteners, connectors, and other like devices. The outer layer 104 may also be coupled directly to the inner layer 102, such as with fasteners, adhesives, welding, and other attachment structures and methods. In a preferred implementation, the present disclosure contemplates a shrink fit between the outer layer 104 and the inner layer 102 that is described in more detail with reference to FIG. 4A and FIG. 4B. The heat generated from the outer layer 104 is conveyed or transferred to the inner layer 102 by direct contact and/or convection between the layers 102, 104 depending on the arrangement of the outer layer 104 relative to the inner layer 102 and the connection therebetween.

The use of a bi-layer or multi-layer pipe, such as pipe 100, is different from the prior solutions discussed herein. The primary difference is the location of the layer or material creating the heat. The factors discussed herein suggest that the high Curie temperature alloy should be placed in a location that is closest to the effluent in order to effectively heat the effluent to the heat of reaction. In the non-limiting example of production of ethylene (i.e., ethylene cracking), this would mean that the high Curie temperature alloy should be placed in the center of the pipe, as shown and described with reference to FIG. 2. From a magnetic and heating efficiency perspective, this can be a challenging approach as flux penetration (skin effect) will challenge the ability for the flux to a) penetrate the conductor (pipe) and, b) create balanced distribution throughout the inside of the conductor. Furthermore, many prior solutions that have the high Curie temperature alloy coming in direct contact with the effluent tend to be made of many small size particles. This may be advantageous because the overall surface area is increased, and the heat transfer from the particles to the effluent is maximized. While making the particles small in size may maximize heat transfer, making the volume of the particles smaller reduces the maximum potential eddy current loss and results in less efficient heating. The pipe 100 described herein does not have the same deficiencies and disadvantages. Instead, the pipe 100 enables high efficiency and selective delivery of induction heating for hydrocarbon processing applications by using a high Curie temperature material outside (i.e., outer layer 104) of the pipe carrying the effluent (i.e., inner layer 102) in order to maintain magnetism at the outer surface of the pipe 100 to maximize losses and therefore heating due to the skin effect.

As a result, and as contemplated in the present disclosure, it is preferable to have a magnetic alloy with a high Curie temperature (i.e., at least above 600 degrees C.) closest to the outer surface of the pipe 100, which is different from the arrangement discussed herein where the alloy is located at the inner surface of the pipe 100 and in direct contact with the effluent. In particular, the disclosure contemplates encasing a relatively standard pipe with an iron cobalt-based alloy. In this way, the flux heating will be mainly generated by the outer layer 104 and transferred to the inner layer 102. The nickel-based or other alloy of the inner layer 102 provides the desirable mechanical, thermal, chemical, and other properties for hydrocarbon processing, while the outer layer 104 has desirable properties for induction heating. Thus, the combination of the layers 102, 104 of different material in the pipe 100 provides the benefits of both materials, namely maximum induction heating efficiency without sacrificing mechanical, thermal, and chemical capabilities, among other beneficial characteristics.

FIG. 4A and FIG. 4B are cross-sectional views of the pipe 100 at room temperature and at an operational temperature, respectively. In an implementation, room temperature is approximately 72 degrees F. (approximately 22.2 degrees C.) and operational temperature is between 650 degrees C. and 1000 degrees C. or more. One potential issue with a bi-layer pipe that is intended for use at high temperature (i.e., around 800 degrees C.) is the differential thermal expansion of the different materials of the layers. Beginning with FIG. 4A, the outer layer 104 may be a sleeve or wrap of material around the inner layer 102. While the scale of FIG. 4A is exaggerated, there may be an air gap or space 110 between the layers 102, 104 at room temperature to account for the differential thermal expansion between the different materials of the layers 102, 104. In an implementation, the inner layer 102 may be a material with a higher coefficient of thermal expansion than the outer layer 104. Thus, at an operating temperature shown in FIG. 4B, such as around 750 degrees C. to 850 degrees C., the inner layer 102 may expand a greater amount than the outer layer 104. The air gap 110 accounts for this difference in expansion between the two layers 102, 104 to avoid expansion of one layer from structurally compromising the other layer 104. In an implementation, the air gap 110 is a gap or space that is under vacuum or filled with another fluid besides air and thus may be referred to more generally as a gap or space accordingly. Further, the inner layer 102 is preferably thicker than the outer layer 104 to reduce costs given that iron cobalt-based materials are more expensive than the alloys considered for the inner layer 102. The thicker inner layer 102 may also provide the mechanical, thermal, and chemical benefits mentioned herein relative to the thinner outer layer 104.

In an implementation, the air gap 110 at room temperature (FIG. 4A) is selected to have a size or thickness between the layers 102, 104 such that the layers 102, 104 are in contact with each other in a shrink fit or interference fit at the operational temperature (FIG. 4B). Thus, the air gap 110 not only accounts for the differential thermal expansion between layers, but also harnesses the differential thermal expansion to enable a shrink fit at operational temperature that assists with transferring heat from the outer layer 104 through direct contact with the inner layer 102. Although FIG. 4B illustrates the air gap 110 to illustrate certain concepts of the present disclosure, it is to be appreciated that where the layers 102, 104 are in a shrink fit at operation temperature there may be minimal, or no air gap 110. In sum, the present disclosure contemplates counteracting potential issues with a bi-metal or bi-layer interface of the pipe 100 at operational temperatures by providing an air gap that approximates the thermal expansion mismatch of the layers 102, 104 to avoid compromising either layer as a result of thermal expansion. At the same time, the air gap 110 also enables a shrink fit that assists with heat transfer, among other benefits.

As described above, in some implementations, it may be advantageous to preserve an airgap between layers 102, 104, regardless of operating temperature. For example, in some implementations, the gap or space 110 (which may be filled with air or another fluid or under vacuum) discussed above with reference to FIG. 4A and FIG. 4B may be constant at all temperatures. This airgap can be used to accommodate for other mechanical factors such as flexing, deflection, and unexpected mismatch in thermal expansion. In such a case, the transfer of heat will be dominated by radiation and convection rather than conduction.

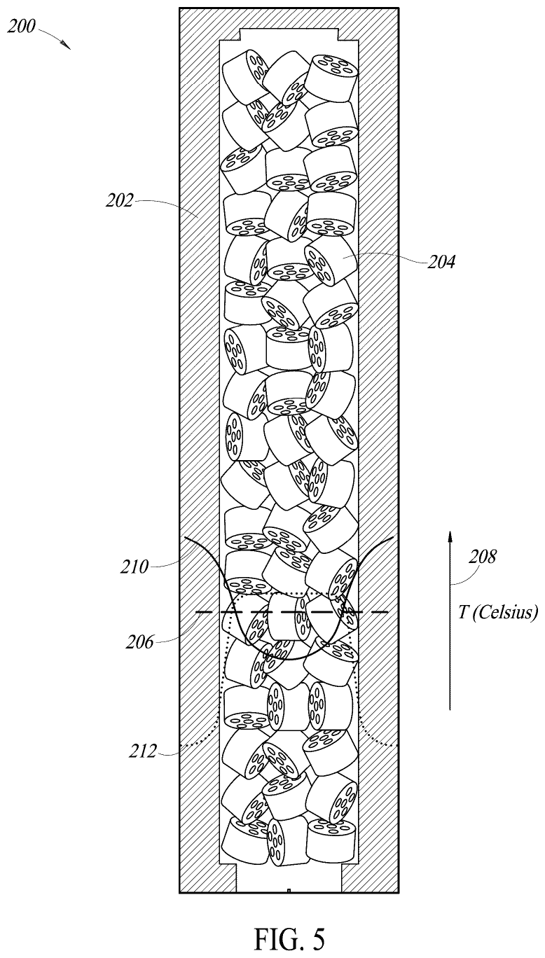

FIG. 5 is a schematic view of an implementation of a pipe 200 that may be utilized in induction heating. In particular, the pipe 200 may be utilized for various reforming processes instead of conventional side-fired heating methods but is not limited thereto. The pipe 200 may include an inner layer 202 in contact with a catalyst 204 or some other process material and/or fluid. The inner layer 202 may be the relatively higher or lower Curie temperature material discussed elsewhere herein. FIG. 5 also schematically illustrates a temperature profile of an induction heating system according to the disclosure relative to conventional side-fired heating methods. Specifically, dashed line 206 may be a desired reaction temperature relative to a range of temperatures that are represented by arrow 208 with higher temperatures being toward the top of the arrow 208. Conventional side-fired heating distributes heat through the outer surface of the workpiece to the inner surface. The heat is then distributed to the process material and/or fluid by convection or radiation. Thus, a heat profile 210 for conventional side-fired heating is expected to result in higher temperatures at the inner surface of the workpiece and lower temperatures toward a center of the material to be processed.

By contrast, induction heating of the type discussed herein may result in additional losses in the material 204 that result in an inverse temperature profile where the temperature is highest in the material 204 and the pipe 200 is generally below the reaction temperature 206. This is represented schematically in FIG. 5 by the temperature profile 212 corresponding to induction heating. Because the temperature in the pipe 200 or workpiece is lower, different materials can be used the outer layer of material for the pipe 200 may not be required to withstand as high of temperatures as with side-fired heating methods. In addition, induction heating may allow for a more controllable and reliable distribution of heat through the material 204 at or above the desired reaction temperature. The temperature profiles 210, 212 illustrate this with the profile 212 for induction heating being flatter and more consistent at or above the desired reaction temperature.

In view of the above, the concepts of the present disclosure provide several benefits and advantages over prior solutions for high temperature induction heating of the type that may be particularly beneficial for hydrocarbon processing applications. For example, the techniques discussed herein provide efficient heating at temperatures above 600 degrees C. and potentially up to 1000 degrees C. (or more) without reaching Curie temperature. The concepts discussed herein also enable operation at high flux densities of >2T while maintaining high permeability at such flux densities. These benefits enable generation of heat both through hysteresis loss and eddy current loss at higher operating temperatures, which lead to the efficiency benefits discussed herein. The disclosure also relies on a generally available iron cobalt-based alloy that does not necessarily require development of a new alloy. The materials discussed herein do not require post processing, such as fine powderization or atomization of alloy into fine particles, which reduces costs. The induction heating systems and methods discussed herein also do not require physical interaction with the effluent and/or the workpiece or pipe. Further, the inner layer of pipe can use existing, less expensive alloys, such as 2535 alloy, to provide the mechanical, thermal, chemical, and other benefits described herein at lower cost. The use of an iron-based alloy allows the induction heating systems and methods to maintain effective hysteresis loss components at high temperature, which increases efficiency and heating vector. Including an iron cobalt-based material also enables operation at relatively wide ranges of frequencies where not all heat is created through eddy current loss. The above benefits also enable the radiative coil to be further from the workpiece or pipe and keeps the coil relatively cool compared to prior solutions. Related methods to the concepts discussed herein are also contemplated.

In one or more implementations, a workpiece for induction heating according to the present disclosure includes: an inner layer; and an outer layer disposed on the inner layer, wherein the inner layer and the outer layer are different materials and the outer layer has a higher Curie temperature than the inner layer.

In an implementation, the inner layer is a nickel-based alloy and the outer layer is a cobalt-based alloy.

In an implementation, the cobalt-based alloy is an iron cobalt-based alloy.

In an implementation, wherein the inner layer has a thickness that is greater than a thickness of the outer layer.

In an implementation, the work piece further includes an air gap between the inner layer and the outer layer at room temperature, wherein at an operational temperature, the inner layer and the outer layer expand to be in contact in a shrink fit.

In an implementation, a Curie temperature of the inner layer is between 550 and 650 degrees C. and a Curie temperature of the outer layer is at least 850 degrees C.

In an implementation, the inner layer and the outer layer have different coefficients of thermal expansion.

In an implementation, the inner layer has a higher coefficient of thermal expansion than the outer layer.

In an implementation, the inner layer is configured to convey an effluent, the effluent in contact with an inner surface of the inner layer and the outer layer spaced from the effluent at least by the inner layer.

In an implementation, the inner layer is an innermost layer and the outer layer is an outermost layer.

In an implementation, the workpiece further includes one or more intermediate layers between the inner layer and the outer layer.

In one or more implementations, a device according to the present disclosure includes a bi-layer pipe configured to convey an effluent, the bi-layer pipe including: an inner layer configured to be in contact with the effluent; and an outer layer surrounding at least a portion of the inner layer, wherein the outer layer has a higher Curie temperature than the inner layer and the outer layer is configured to be spaced from the effluent at least by the inner layer.

In an implementation, the inner layer is a nickel-based alloy and the outer layer is a cobalt-based alloy.

In an implementation, the cobalt-based alloy is an iron cobalt-based alloy.

In an implementation, the inner layer has a thickness that is greater than a thickness of the outer layer.

In an implementation, a Curie temperature of the outer layer is at least 900 degrees C.

In an implementation, a Curie temperature of the inner layer is approximately 600 degrees C.

In an implementation, the outer layer is in contact with at least a portion of the inner layer at operational temperature in a shrink fit.

In an implementation, a coefficient of thermal expansion of the outer layer is greater than a coefficient of thermal expansion of the inner layer.

In an implementation, the device further includes an air gap between the inner layer and the outer layer at room temperature to account for differential thermal expansion of the inner layer and the outer layer at an operating temperature.

In an implementation, the bi-layer pipe includes only the inner layer and the outer layer.

In one or more implementations, a method is performed according to any of the preceding implementations.

In one or more implementations, a method according to the present disclosure includes heating a fluid in a bi-layer pipe including an inner layer in contact with the fluid and an outer layer surrounding at least a portion of the inner layer, wherein the outer layer has a higher Curie temperature than the inner layer.

In one or more implementations, a method according to the present disclosure includes: flowing a fluid through an inner layer of a multi-layer pipe; supplying electricity to an electromagnetic source to generate magnetic flux; flowing the magnetic flux through the multi-layer pipe, including flowing the magnetic flux through an outer layer of the multi-layer pipe with a higher Curie temperature than the inner layer; and heating the fluid flowing through the inner layer of the multi-layer pipe via hysteresis loss and eddy current loss in at least a portion of the outer layer and a portion of the inner layer.

In an implementation, the method further includes maintaining the hysteresis loss at least in the outer layer to and beyond a reaction temperature of the fluid via the higher Curie temperature of the outer layer.

In an implementation, heating the fluid includes flowing the fluid through and in contact with the inner layer and the outer layer being spaced from the fluid at least by the inner layer.

In an implementation, the inner layer is a nickel-based alloy and the outer layer is a cobalt-based alloy.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the induction heating context, and are not limited to the example induction heating systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with induction heating devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/588,894 filed on Oct. 9, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A workpiece for induction heating, comprising:
an inner layer; and
an outer layer disposed on the inner layer, wherein the inner layer and the outer layer are different materials and the outer layer has a higher Curie temperature than the inner layer.

2. The workpiece of claim 1, wherein the inner layer is a nickel-based alloy and the outer layer is a cobalt-based alloy.

3. The workpiece of claim 2, wherein the cobalt-based alloy is an iron cobalt-based alloy.

4. The workpiece of claim 1, wherein the inner layer has a thickness that is greater than a thickness of the outer layer.

5. The workpiece of claim 1, further comprising:
an air gap between the inner layer and the outer layer.

6. The workpiece of claim 1, wherein a Curie temperature of the inner layer is between 550 and 650 degrees C. and a Curie temperature of the outer layer is at least 850 degrees C.

7. The workpiece of claim 1, wherein the inner layer and the outer layer have different coefficients of thermal expansion.

8. The workpiece of claim 1, wherein the inner layer has a higher coefficient of thermal expansion than the outer layer.

9. The workpiece of claim 1, wherein the inner layer is configured to convey an effluent, the effluent in contact with an inner surface of the inner layer and the outer layer spaced from the effluent at least by the inner layer.

10. The workpiece of claim 1, wherein the inner layer is an innermost layer and the outer layer is an outermost layer.

11. The workpiece of claim 1, further comprising:
one or more intermediate layers between the inner layer and the outer layer.

12. A device, comprising:
a bi-layer pipe configured to convey an effluent, the bi-layer pipe including:
an inner layer configured to be in contact with the effluent; and
an outer layer surrounding at least a portion of the inner layer, wherein the outer layer has a higher Curie temperature than the inner layer and the outer layer is configured to be spaced from the effluent at least by the inner layer.

13. The device of claim 12, wherein the inner layer is a nickel-based alloy and the outer layer is a cobalt-based alloy.

14. The device of claim 13, wherein the cobalt-based alloy is an iron cobalt-based alloy.

15. The device of claim 12, wherein the inner layer has a thickness that is greater than a thickness of the outer layer.

16. The device of claim 12, wherein a Curie temperature of the outer layer is at least 900 degrees C.

17. The device of claim 16, wherein a Curie temperature of the inner layer is approximately 600 degrees C.

18. The device of claim 12, wherein the outer layer is in contact with at least a portion of the inner layer at operational temperature in a shrink fit.

19. The device of claim 12, wherein a coefficient of thermal expansion of the outer layer is greater than a coefficient of thermal expansion of the inner layer.

20. The device of claim 12, further comprising:
an air gap between the inner layer and the outer layer at room temperature to account for differential thermal expansion of the inner layer and the outer layer at an operating temperature.

21. The device of claim 12, wherein the bi-layer pipe includes only the inner layer and the outer layer.

22. A method, comprising:
flowing a fluid through an inner layer of a multi-layer pipe;
supplying electricity to an electromagnetic source to generate magnetic flux;
flowing the magnetic flux through the multi-layer pipe, including flowing the magnetic flux through an outer layer of the multi-layer pipe with a higher Curie temperature than the inner layer; and
heating the fluid flowing through the inner layer of the multi-layer pipe via hysteresis loss and eddy current loss in at least a portion of the outer layer and a portion of the inner layer.

23. The method of claim 22, further comprising:
maintaining the hysteresis loss at least in the outer layer to and beyond a reaction temperature of the fluid via the higher Curie temperature of the outer layer.

24. The method of claim 22, wherein heating the fluid includes flowing the fluid through and in contact with the inner layer and the outer layer being spaced from the fluid at least by the inner layer.

25. The method of claim 22, wherein the inner layer is a nickel-based alloy and the outer layer is a cobalt-based alloy.
